(19) United States
(12) Patent Application Publication
(10) Pub. No.: US 2017/0094692 A1
(43) Pub. Date: Mar. 30, 2017

(54) WIFI Hotspot Connection and Selection Method, Communications Terminal and System

(71) Applicant: ZTE CORPORATION, Shenzhen City, Guangdong Province (CN)

(72) Inventor: Yuelong ZHANG, Shenzhen (CN)

(21) Appl. No.: 15/121,764

(22) PCT Filed: Jun. 24, 2014
(86) PCT No.: PCT/CN2014/080565

§ 371 Date: Aug. 25, 2016

(30) Foreign Application Priority Data
Feb. 27, 2014 (CN) 201410068004.3

(51) Int. Cl. H04W 76/02; H04W 12/06; H04L 29/06

(52) U.S. Cl. CPC H04W 76/02; H04L 63/0815; H04W 12/06; H04W 84/12

(57) ABSTRACT

The present document discloses a method for connecting and selecting a WIFI hotpot, a communication terminal and system. A communication terminal selects and connects to a WIFI hotpot without encryption; and sends preset verification information to a network server; and after receiving verification information and comparing with locally-preset verification information, the network server feeds back verification information to the communication terminal when the received verification information is consistent with the locally-preset verification information; and the communication terminal receives verification information fed back by the network server and compares with locally-preset verification information, then keeps the connection with the WIFI hotpot when the verification information fed back by the network server is consistent with the locally-preset verification information.

### TECHNICAL FIELD

The present document relates to a communication filed, and in particular to a method for connecting and selecting a WIFI hotpot, and a communication terminal and system.

### BACKGROUND OF THE RELATED ART

With fast development of Internet and everyday change of communication technology, operators and various merchants start to provide WIFI hotpots without encryption at many different locations (such as airports and coffee shops) gradually so as to attract consumers and provide convenient Internet access for consumers.

However, WIFI devices without encryption provided by operators and merchants have fundamental differences on user experience because of different properties. The WIFI hotpot without encryption provided by an operator is one of Internet pay services and needs the second verification on an operator page after a connection is established, then Internet can be really accessed, while the WIFI hotpot provided by a merchant can be used directly to access Internet after a connection is established without a second verification. In many cases the strength of an operator is far stronger than that of a merchant, so that the signal quality of the operator WIFI hotpot without encryption is better than that of the merchant. Therefore, when selecting and connecting to a WIFI hotpot without encryption, a user has to verify manually whether a WIFI hotpot needs a second verification and selection even though a WIFI management software supports to join in a WIFI hotpot automatically. The process is so complex that the satisfaction of user experience will be reduced in a great degree.

### SUMMARY

In order to solve the existing technical problems, the embodiments of the present document provide a method for selecting and connecting a WIFI hotpot, a communication terminal and system.

To solve the problems, the embodiments of the present document provide a method for connecting a WIFI hotpot, which includes:

connecting, by a communication terminal, to a WIFI hotpot without encryption;

sending, by the communication terminal, preset verification information to a network server; and

receiving, by the communication terminal, verification information fed back by the network server and comparing with the locally-preset verification information, then keeping the connection with the WIFI hotpot when the verification information fed back from the network server is consistent with the locally-preset verification information.

In an embodiment of the present document, when the communication terminal determines that the verification information fed back by the network server is not consistent with the locally-preset verification information, the method further comprises:

reselecting and connecting to a WIFI hotpot without encryption by the communication terminal; or

after deleting, by the communication terminal, the WIFI hotpot from a list of WIFI hotpots without encryption, then reselecting and connecting to a WIFI hotpot without encryption by the communication terminal; or

exiting, by the communication terminal, the connection with the WIFI directly.

In an embodiment of the present document, before connecting, by the communication terminal, to a WIFI hotpot without encryption, the method further comprises:

deleting an operator WIFI hotpot from WIFI hotpots without encryption searched out by the communication terminal according to preset operator WIFI hotpot information.

In an embodiment of the present document, before sending, by the communication terminal, preset verification information to a network server, the method further comprises:

encrypting, by the communication terminal, the verification information which is to be sent; and/or

before comparing, by the communication terminal, the received verification information with the locally-preset verification information, the method further comprises:

decrypting the received verification information.

To solve the problems, the present document embodiments provide a method for selecting a WIFI hotpot, which includes:

connecting, by a communication terminal, to a WIFI hotpot without encryption;

sending, by the communication terminal, preset verification information to a network server, and presetting verification information in the network server.

receiving, by the network server, verification information sent by the communication terminal and comparing with locally-preset verification information, then feeding back verification information to the communication terminal when the verification information sent by the communication terminal is consistent with the locally-preset verification information;

receiving, by the communication terminal, verification information fed back by the network server and comparing with locally-preset verification information, then keeping the connection with the WIFI hotpot when the verification information fed back by the network server is consistent with the locally-preset verification information.

In an embodiment of the present document, when the network server determines that verification information sent by the communication terminal is not consistent with the locally-preset verification information, or the communication terminal determines that the verification information fed back the network server is not consistent with the locally-preset verification information, the method further comprises:

reselecting and connecting to a WIFI hotpot without encryption by the communication terminal; or

after deleting, by the communication terminal, the WIFI hotpot from a list of WIFI hotpots without encryption, then reselecting and connecting to a WIFI hotpot without encryption by the communication terminal; or

exiting, by the communication terminal, the connection with the WIFI directly.

In an embodiment of the present document, before sending, by the communication terminal, preset verification information to a network server, the method further comprises:

encrypting, by the communication terminal, the verification information which is to be sent;

accordingly, before comparing, by the network server, the received verification information with the locally-preset verification information, the method further comprising:

decrypting the received verification information.

In an embodiment of the present document, before feeding back, by the network server, the verification information, the method further comprises:

encrypting, by the network server, the verification information which is to be sent;

accordingly, before comparing, by the communication terminal, the received verification information with the locally-preset verification information, the method further comprises:

decrypting the received verification information.

In an embodiment of the present document, the communication terminal encrypts the verification information which is to be sent into binary verification data information.

In an embodiment of the present document, the network server encrypts the verification information which is to be sent into binary verification data information.

To solve the problems, the embodiments of the present document provide a communication terminal which includes a WIFI communication module, a first sending module, a first receiving module and a first processing module; wherein,

the WIFI communication module is configured to connect to a WIFI hotpot without encryption;

the first sending module is configured to send verification information locally preset in the communication terminal to a network server;

the first receiving module is configured to receive verification information fed back by the network server;

the first processing module is configured to compare the verification information received by the first receiving module with the verification information locally preset in the communication terminal, and keep the connection between the WIFI communication module and the WIFI hotpot when the verification information received by the first receiving module is consistent with the verification information locally preset in the communication terminal.

In an embodiment of the present document, the communication terminal further comprises a reselecting module, and the reselecting module is configured to, when the first processing module determines that the verification information received by the first receiving module is not consistent with the verification information locally preset in the communication terminal, reselect a WIFI hotpot without encryption to connect to the WIFI communication module; or delete the WIFI hotpot from a list of WIFI hotpots without encryption, then reselect a WIFI hotpot without encryption to connect to the WIFI communication module.

In an embodiment of the present document, the communication terminal further comprises a screening module, and the screening module is configured to delete an operator WIFI hotpot from WIFI hotpots without encryption searched out by the WIFI communication terminal according to preset operator WIFI hotpot information before the WIFI communication module selects and connects to a WIFI hotpot without encryption.

In an embodiment of the present document, wherein the communication terminal further comprises a first encrypting module and a first decrypting module, and the first encrypting module is configured to encrypt the verification information which is to be sent before the first sending module sends the verification information to the network server; and/or, the first decrypting module is configured to decrypt the verification information received by the first receiving module before the first processing module compares the verification information received by the first receiving module with the verification information locally preset in the communication terminal.

To solve the problems, the embodiments of the present document provide a communication system which includes a communication terminal and a network server;

the communication terminal comprises: a WIFI communication module, a first sending module, a first receiving module and a first processing module; and the network server comprises a second receiving module, a second sending module and a second processing module;

the WIFI communication module is configured to select and connect to a WIFI hotpot without encryption;

the first sending module is configured to send verification information locally preset in the communication terminal to the second receiving module;

the second receiving module is configured to receive the verification information sent by the first sending module;

the second processing module is configured to compare the verification information received by the second receiving module with verification information locally preset in the network server, and make verification information be sent by the second sending module to the first receiving module when the verification information received by the second receiving module is consistent with the verification information locally preset in the network server;

the first receiving module is configured to receive the verification information sent by the second sending module;

the first processing module is configured to compare the verification information received by the first receiving module with the verification information locally preset in the communication terminal, and keep the connection between the WIFI communication module and the WIFI hotpot when the verification information received by the first receiving module is consistent with the verification information locally preset in the communication terminal.

In an embodiment of the present document, the communication terminal further comprises: a first encrypting module and a first decrypting module, and the network server further comprises a second decrypting module and a second encrypting module, wherein,

the first encrypting module is configured to encrypt the verification information which is to be sent before the first sending module sends the verification information to the network server;

the first decrypting module is configured to decrypt verification information received by the first receiving module before the first processing module compares verification information received by the first receiving module with the verification information locally preset in the communication terminal;

the second decrypting module is configured to decrypt verification information received by the second receiving module before the second processing module compares verification information received by the second receiving module with the verification information locally preset in the network server;

the second encrypting module is configured to encrypt verification information which is to be sent before the second sending module sends the verification information to the communication terminal.

To solve the problems, the embodiments of the present document provide a computer storage medium, the computer storage medium comprises a group of instructions, which, when executed, cause at least one processor to implement the method for a selecting WIFI hotpot.

A good effect of the embodiments of the present document includes:

The embodiments of the present document provide a method for selecting and connecting a WIFI hotpot, a communication terminal and system. A communication terminal selects and connects to a WIFI hotpot without encryption, then sends preset verification information to a network server. The network server is also preset with verification information. Then the network server receives verification information and compares with the locally-preset verification information, then feeds back verification information to the communication terminal when the received verification information is consistent with the locally-preset verification information. The communication terminal receives verification information fed back by the network server and compares with the locally-preset verification information, then keeps the connection with the WIFI hotpot when the verification information fed back by the network server is consistent with the locally-preset verification information which indicates that the currently connected WIFI hotpot is a hotpot which does not need a second verification. Therefore, with preset verification information, the communication terminal of the present document realizes to screen automatically a WIFI hotpot which needs a second verification from WIFI hotpots without encryption, and the user does not need to verify and select by hand, which simplifies operation process of WIFI communication and improves the satisfaction of user experience in a large degree.

### BRIEF DESCRIPTION OF DRAWINGS

In accompanying drawings (they are not necessarily drawn to scale), the similar reference symbols in the drawings can describe the similar parts in the different views. The similar reference symbols having different letter suffixes can represent different instances of the similar parts. Various embodiments discussed herein are substantially illustrated in the drawings in the form of instances instead of the limitation.

FIG. 1 is a flow diagram of a method for selecting a WIFI hotpot according to a first embodiment of the present document.

FIG. 2 is a structural diagram of a communication system according to a second embodiment of the present document.

FIG. 3 is a first structural diagram of a communication terminal according to a second embodiment of the present document.

FIG. 4 is a first structural diagram of a network server according to a second embodiment of the present document.

FIG. 5 is a second structural diagram of a communication terminal according to a second embodiment of the present document.

FIG. 6 is a third structural diagram of a communication terminal according to a second embodiment of the present document.

FIG. 7 is a second structural diagram of a network server according to a second embodiment of the present document.

FIG. 8 is a flow diagram of a method for selecting a WIFI hotpot in a first application scenario according to a third embodiment of the present document.

FIG. 9 is a flow diagram of processing verification information by a network server according to an embodiment of the present document in FIG. 8.

FIG. 10 is a flow diagram of a method for selecting a WIFI hotpot in a second application scenario according to a third embodiment of the present document.

FIG. 11 is a flow diagram of a method for selecting a WIFI hotpot in a third application scenario according to a third embodiment of the present document.

### SPECIFIED EMBODIMENTS

The present document will be described in detail below in combination with the drawings through specified embodiments.

### The First Embodiment

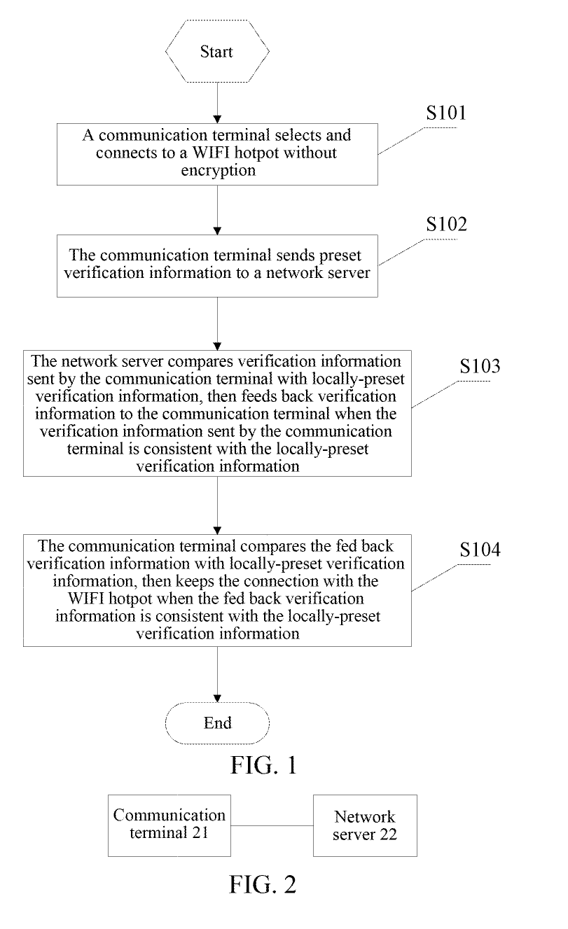

As shown in FIG. 1, a method for selecting a WIFI hotpot provided by the embodiment of the present document includes the following steps:

In step 101, a communication terminal selects and connects to a WIFI hotpot without encryption.

In step 102, the communication terminal sends preset verification information to a network server, and the verification information is preset in the network server.

In step 103, the network server receives verification information sent by the communication terminal and compares with the locally-preset verification information, then feeds back verification information to the communication terminal when the verification information sent by the communication terminal is consistent with the locally-preset verification information.

In step 104, the communication terminal receives verification information fed back from the network server and compares with the locally-preset verification information, then keeps connection with the WIFI hotpot when the verification information fed back from the network server is consistent with the locally-preset verification information which indicates that the WIFI hotpot currently connected with the communication terminal does not need a second verification.

Therefore, by means of preset verification information, the communication terminal in the present embodiment realizes screening automatically a WIFI hotpot which needs a second verification from WIFI hotpots without encryption and does not need to verify and select by hand, which simplifies operation process of WIFI communication and improves the satisfaction of user experience in a large degree. At the same time, in a large degree, the communication terminal also avoids to connect wrongly to a WIFI hotpot without encryption which is provided by an operator and needs a second verification, which reduces users' economic expense and further improves users' satisfaction.

The communication terminal in the aforementioned step 101 may be any terminal equipment which has a communication function, such as mobile phone, IPAD and so on. The ways for selecting a WIFI hotpot may be any one of the following:

In way 1, the communication terminal searches for a WIFI hotpot without encryption and acquires a list of WIFI hotpots without encryption; then the communication terminal selects one from the WIFI hotpot list to connect with it; the communication terminal may select the WIFI hotpot with the best signal quality, or select the WIFI hotpot according to users' specified order, or even select randomly the WIFI hotpot from the list and so on.

In way 2, the communication terminal searches for a corresponding WIFI hotpot directly according to the WIFI hotpot information input by the user, and then connects with it.

In step 103, when the network server makes sure that the verification information sent by the communication terminal is not consistent with the locally-preset verification information, the network server may inform the communication terminal to reselect a WIFI hotpot without encryption to connect with it, and then it is to jump to step 102, until the communication terminal selects a WIFI hotpot without encryption which does not need a second verification or there is no WIFI hotpot without encryption left.

In step 104, when the communication terminal makes sure that the verification information sent by the network server is not consistent with the locally-preset verification information, the communication terminal reselects and connects to a WIFI hotpot without encryption and then it is to jump to step 102, until the communication terminal selects a WIFI hotpot without encryption which does not need a second verification or there is no WIFI hotpot without encryption left.

Certainly, in the aforementioned step 103 and step 104, when the comparison result of verification information is inconsistent, the communication terminal may reselect and connect to a WIFI hotpot without encryption from the list after deleting the currently verified WIFI hotpot from the list of WIFI hotpots without encryption. In some application scenarios, the communication terminal may exit the connection with the WIFI directly, for example, in a case that there is only one WIFI hotpot without encryption in the current WIFI hotpot list, or in other cases.

In order to improve success rate of subsequent verification in this embodiment, a step of deleting an operator WIFI hotpot may also be included before the aforementioned step 101. Specifically, according to preset operator WIFI hotpot information, an operator WIFI hotpot may be deleted from WIFI hotpots without encryption which are searched out by the communication terminal. More specifically, WIFI hotpot information (such as names and so on) provided by various operators may be firstly preset, the WIFI hotpot information may be preset locally in the communication terminal, and may also be preset in other equipments from which the communication terminal may acquire information, then after the communication terminal completes a searching for a WIFI hotpot without encryption and acquires a list of WIFI hotpots without encryption, the communication terminal deletes an operator WIFI hotpot from the list according to preset operator WIFI hotpot information.

In this embodiment, in order to ensure verification information is not tampered by a WIFI hotpot which needs a second verification during transmission, the verification information which is to be sent may be encrypted before sending the verification information to the opposite. Specifically, in the aforementioned step 102 the communication terminal will encrypt the verification information which is to be sent before sending the verification information to a network server; and/or in the aforementioned step 103, the network server will encrypt the verification information which is to be sent before sending it to the communication terminal. Accordingly, before the communication terminal and/or network server compares received verification information with locally-preset verification information, a step of decrypting received verification information is also included. The specific encrypting/decrypting algorithm in this embodiment may be selected according to specific application scenarios and does not need to be repeated here. In order to further ensure security and reliability of encryption, a communication terminal and/or network server will encrypt the verification information which is to be sent into binary verification data information in the embodiment.

It should be noted that verification information in this embodiment is any data information that has a function of distinguishing and discriminating in theory. A specific format and content of the verification information may be set according to specific application scenarios so that to ensure the security and reliability of the information.

### The Second Embodiment

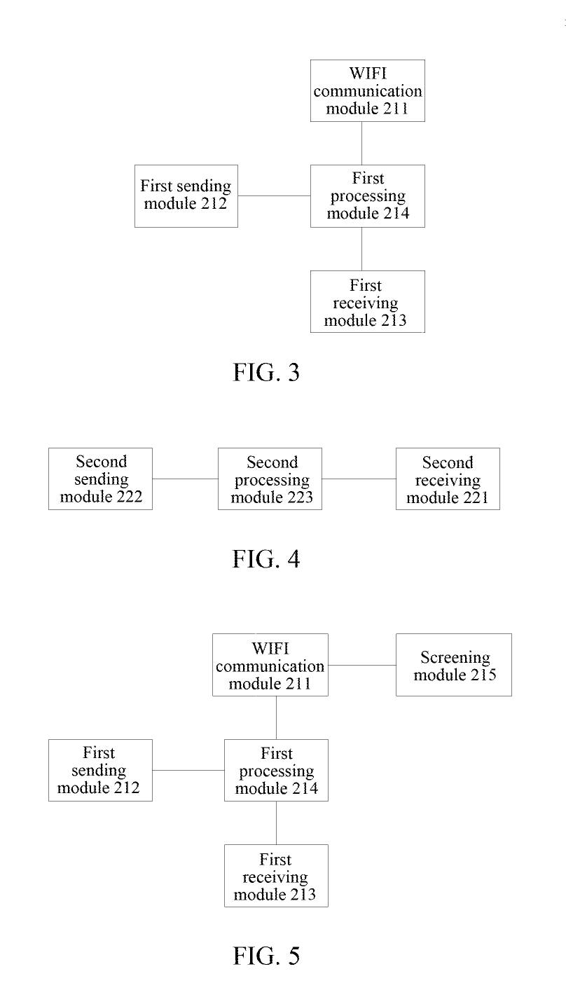

As shown in FIG. 2, the embodiment of the present document provides a communication system which includes a communication terminal 21 and a network server 22; wherein as shown in FIG. 3 and FIG. 4, the communication terminal includes a WIFI communication module 211, a first sending module 212, a first receiving module 213 and a first processing module 214; the network server includes a second receiving module 221, a second sending module 222 and a second processing module 223;

The WIFI communication module 211 of the communication terminal is configured to select and connect to a WIFI hotpot without encryption; the way for selecting a WIFI hotpot may be any one of the following:

In way 1, the communication terminal searches for a WIFI hotpot without encryption and acquires a list of WIFI hotpots without encryption; then the communication terminal selects and connects to one WIFI hotpot in the WIFI hotpot list; when selecting a WIFI hotpot, the communication terminal may select the WIFI hotpot with the best signal quality, or select the WIFI hotpot according to users' specified order, or even select randomly the WIFI hotpot from the list and so on.

In way 2, the communication terminal searches for the WIFI hotpot directly according to the WIFI hotpot information input by the user, and then connects with it.

The first sending module 212 of the communication terminal is configured to send verification information locally preset in the communication terminal to the network server after connecting to a WIFI hotpot without encryption;

the second receiving module 221 of the network server is configured to receive the verification information sent by the first sending module 212;

the second processing module 223 of the network server is configured to compare the verification information received by the second receiving module 221 with the verification information locally preset in the network server, and send verification information to the communication terminal when the verification information received by the second receiving module 221 is consistent with the verification information locally preset in the network server;

the first receiving module 213 of the communication terminal is configured to receive verification information sent by the second sending module 223;

the first processing module 214 of the communication terminal is configured to compare the verification information received by the first receiving module 213 with the locally-preset verification information, and keep connection between the WIFI communication module 211 and the WIFI hotpot when the verification information received by the first receiving module 213 is consistent with the locally-preset verification information, which indicates that the currently connected WIFI hotpot without encryption does not need a second verification.

In this embodiment, the communication terminal further comprises a reselecting module, and the reselecting module is configured to reselect a WIFI hotpot without encryption to connect to the WIFI communication module 211 when the first processing module 214 determines that the verification information received by the first receiving module 213 is not consistent with the verification information locally preset in the communication terminal; or reselect a WIFI hotpot without encryption to connect to the WIFI communication module 211 after the currently connected WIFI hotpot is deleted from a list of WIFI hotpots without encryption. And the reselecting module is also configured to reselect a WIFI hotpot without encryption to connect to the WIFI communication module 211 when the second processing module 223 of the network server determines that the verification information received by the second receiving module 221 is not consistent with the verification information locally stored in the network server; or reselect a WIFI hotpot without encryption to connect to the WIFI communication module 211 after the currently connected WIFI hotpot is deleted from a list of WIFI hotpots without encryption.

As shown in FIG. 5, the communication terminal in this embodiment further comprises a screening module 215. The screening module 215 is configured to delete an operator WIFI hotpot before the WIFI communication module selects and connects to a WIFI hotpot without encryption so that to improve success rate of subsequent verification. Specifically, the screening module 215 deletes an operator WIFI hotpot from WIFI hotpots without encryption searched out by the communication terminal according to preset operator WIFI hotpot information. More specifically, WIFI hotpot information (such as names and so on) provided by various operators may be firstly preset, the WIFI hotpot information may be locally preset in the communication terminal or may also be preset in other equipments from which the communication terminal may acquire information, then after the communication terminal completes a searching for a WIFI hotpot without encryption and acquires a WIFI hotpot without encryption list, the communication terminal deletes an operator WIFI hotpot from the list according to preset operator WIFI hotpot information.

As shown in FIG. 6, in order to ensure the security of the verification information in the transmission, the communication terminal of this embodiment further comprises a first encrypting module 216 and a first decrypting module 217. Wherein, the first encrypting module 216 is configured to encrypt verification information which is to be sent before the first sending module 212 of the communication terminal sends the verification information to the network server; the first decrypting module 217 is configured to decrypt verification information received by the first receiving module 211 before the first processing module 214 compares verification information received by the first receiving module 211 with the local verification preset in the communication terminal.

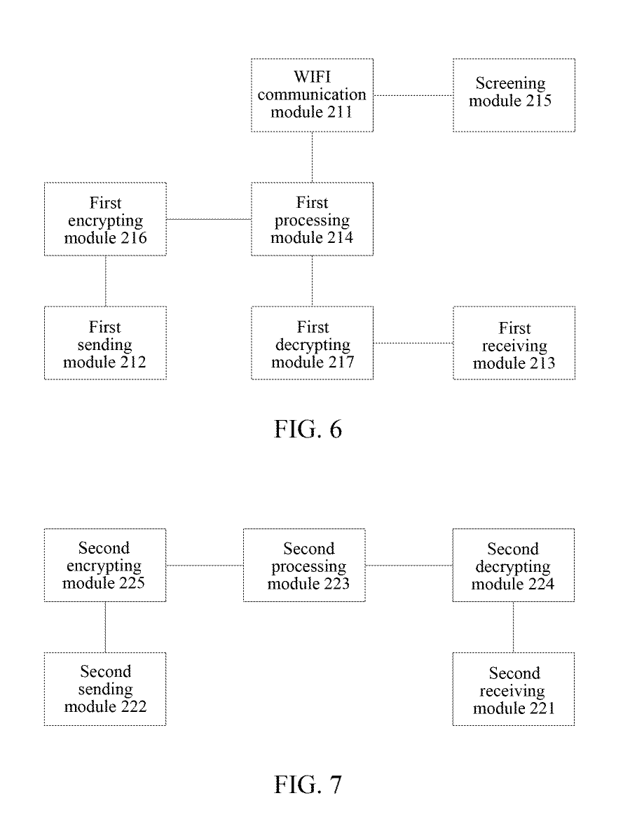

Accordingly, as shown in FIG. 7, the network server in the embodiment further comprises a second decrypting module 224 and a second encrypting module 225. The second decrypting module 224 is configured to decrypt verification information received by the second receiving module 221 before the second processing module 223 of the network server compares verification information received by the second receiving module 221 with the verification information locally preset in the network server; the second encrypting module 225 is configured to encrypt verification information which is to be sent before the second sending module 222 of the network server sends verification information to the communication terminal.

In order to further ensure security of verification information in the transmission, the first encrypting module 216 and the second encrypting module 224 in the embodiment may specifically encrypt the verification information which is to be sent into binary verification data information. The specific encrypting algorithm may be selected according to specific application scenarios.

In practice, the WIFI communication terminal 211 may be implemented by combination circuit of CPU (Central Processing Unit), DSP (Digital Signal Processor), or FPGA (Field-Programmable Gate Array) in a communication terminal; the first sending module 212 may be implement by a transmitter in the communication terminal; the first receiving module 213, the first encrypting module 216 and the first decrypting module 217 may be implemented by a receiver in the communication terminal; the first processing module 214, reselecting module, screening module 215 may be implemented by CPU, DSP or FPGA in the communication terminal; the reselecting module may be implemented by CPU, DSP or FPGA in the communication terminal; the second receiving module 221 may be implemented by a receiver in a network server; the second sending module 222 may be implemented by a transmitter in the network server; the second processing module 223, the second decrypting module 224 and the second encrypting module 225 may be implemented by CPU, DSP or FPGA in the network server.

### The Third Embodiment

In order to understand the solution of the present document better, the present document will be further described below in combination with some specific application scenarios.

Application Scenario 1:

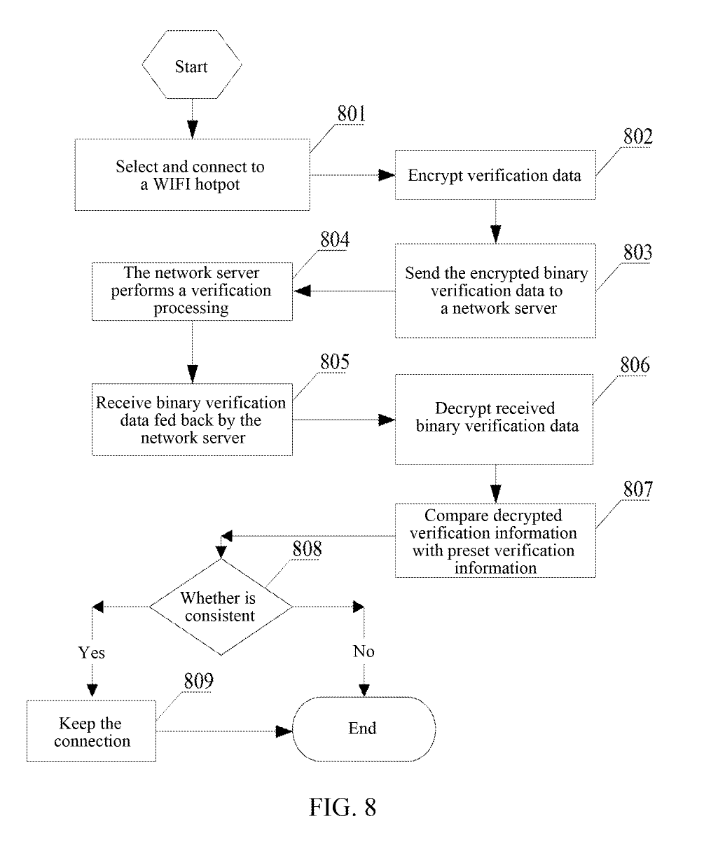

The verification procedure is just for a single WIFI hotpot without encryption, and the single WIFI hotpot without encryption may be designated by user or may be the only one WIFI hotpot without encryption that is searched currently, or the like. As shown in FIG. 8, the following steps are included:

In step 801, the communication terminal connects to the WIFI hotpot without encryption.

In step 802, the communication terminal encrypts verification information which is to sent, and encrypts the verification information into binary verification data information; and 1024-bit RSA encryption may be used in this step.

In step 803, the communication terminal sends the encrypted verification information to a corresponding network server.

In step 804, the network server verifies the received verification information, and feeds back encrypted verification information to the communication terminal after verifying that verification information received by the network server is consistent with the locally-preset verification information;

In step 805, the communication terminal receives verification information sent by network server;

In step 806, the communication terminal decrypts received verification information;

In step 807, the communication terminal compares decrypted verification information with locally-preset verification information;

In step 808, the communication terminal determines whether verification information decrypted by the communication terminal is consistent with locally-preset verification information; if so, it is to jump to step 809; if not, it is to end the process.

In step 809, the connection with the WIFI hotpot without encryption is kept.

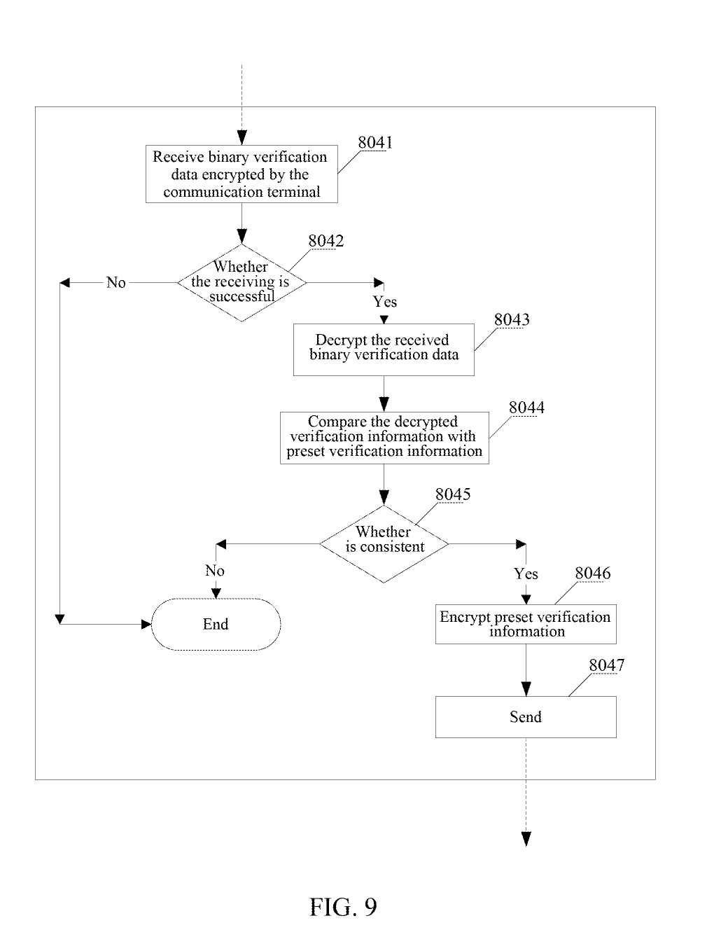

In step 804, the procedure of the network server verifying verification information received by the network server is shown in FIG. 9, which includes:

In step 8041, the network server receives binary verification data information sent by the communication terminal.

In step 8042, the network server determines whether the receiving is successful; if so, it is to jump to step 8043; if not, it is to end the process.

In step 8043, the network server decrypts the received binary verification data information.

In step 8044, the network server compares decrypted verification information with the locally-preset verification information.

In step 8045, the network server determines whether the decrypted verification information is consistent with the locally-preset verification information; if so, it is to jump to step 8046; if not, it is to end the process.

In step 8046, the network server encrypts the locally-preset verification information. The locally-preset verification information may be encrypted into binary verification data information by using 1024-bit RSA encryption algorithm;

In step 8047, the network server sends the encrypted verification information to the communication terminal.

Application Scenario 2:

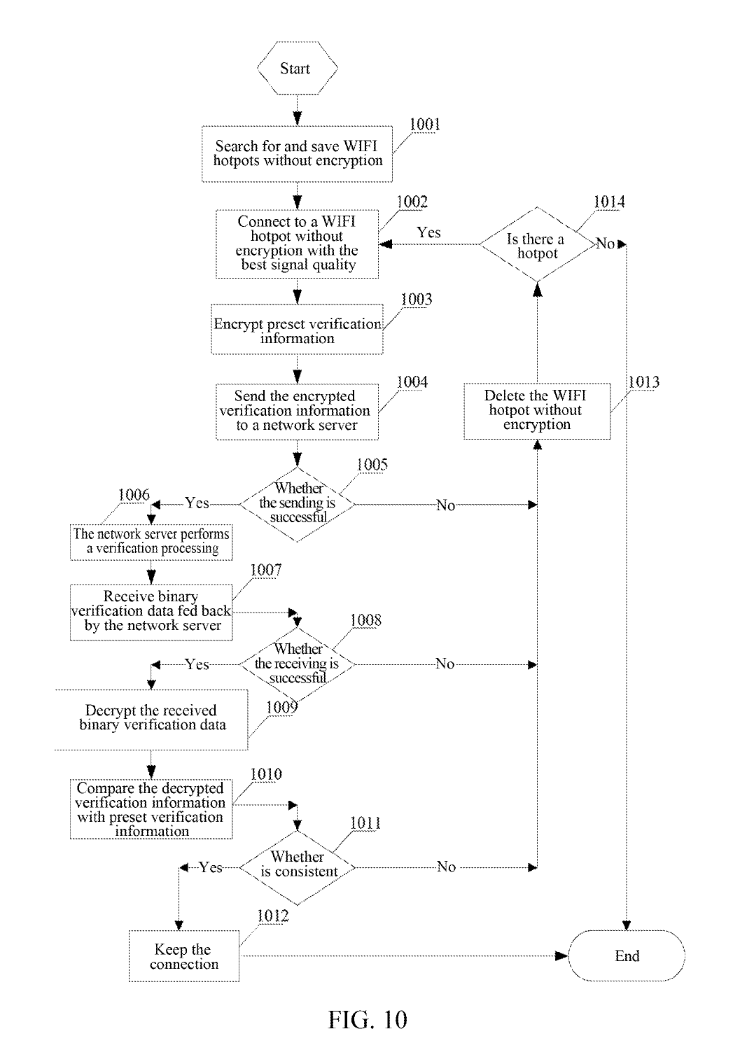

The application scenario 1 just takes a single WIFI hotpot as an example. However a communication terminal can usually search for more than one WIFI hotpots without encryption in many application scenarios. The procedure of verifying multiple WIFI hotpots without encryption searched-out by a communication terminal will be described. As shown in FIG. 10, the steps are included:

In step 1001, a communication terminal searches for and saves a WIFI hotpot without encryption, then obtains a list of WIFI hotpots without encryption.

In step 1002, the communication terminal selects and connects to a WIFI hotpot without encryption from the list of WIFI hotpots without encryption. Specifically, the WIFI hotpot with best signal quality may be selected; certainly, the WIFI hotpot may also be selected according to other rules set by users.

In step 1003, the communication terminal encrypts verification information which is to be sent, and encrypts the verification information into binary verification data information.

In step 1004, the communication terminal sends the encrypted verification information to a corresponding network server.

In step 1005, the communication terminal determines whether the verification information is sent successfully, if so, it is to jump to step 1006; if not, it is to jump to step 1013.

In step 1006, the network server verifies the received verification information and feeds back encrypted verification information to the communication terminal after verifying that the received verification information is consistent with the locally-preset verification information;

In step 1007, the communication terminal receives verification information sent by the network server;

In step 1008, the communication terminal determines whether the verification information is received successfully, if so, it is to jump to step 1009; if not, it is to jump to step 1013.

In step 1009, the communication terminal decrypts the received verification information;

In step 1010, the communication terminal compares the decrypted verification information with locally-preset verification information.

In step 1011, the communication terminal determines whether the decrypted verification information is consistent with the locally-preset verification information; if so, it is to jump to step 1012; if not, it is to jump to step 1013.

In step 1012, the connection with the WIFI hotpot without encryption is kept.

In step 1013, the currently connected WIFI hotpot is deleted;

In step 1014, it is to determine whether there is a remained WIFI hotpot in the list of WIFI hotpot without encryption, if so, it is to jump to step 1002; if not, it is to end the process.

The process of verifying verification information by the network server is similar to the process as shown in FIG. 9, so there is no necessary to repeat here.

Application Scenario 3:

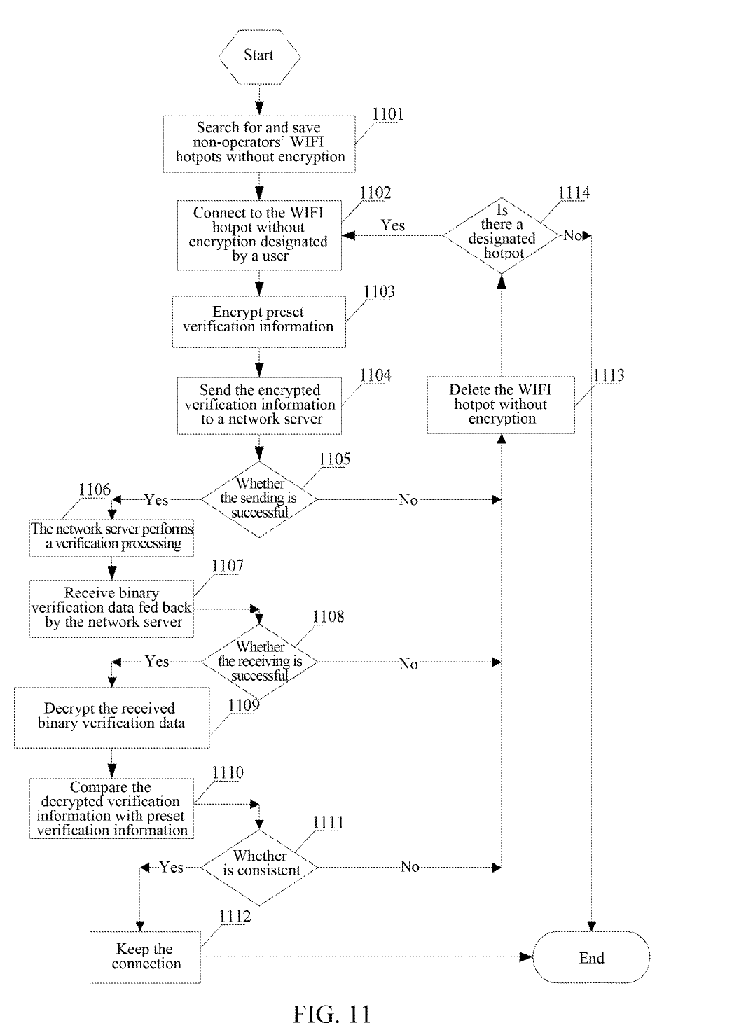

A communication terminal can search for more than one WIFI hotpots without encryption in many application scenarios. The more than one WIFI hotpots may include WIFI hotpots which need a second verification and are provided by operators, and also include WIFI hotpots which do not need a second verification and are provided by other merchants. Therefore firstly the WIFI hotpots without encryption provided by merchants may be deleted from the searched-out WIFI hotpots without encryption, then a process of connecting and verifying goes on, which can improve success rate of verification. And the communication terminal may connect to a WIFI hotpot designated by user when selecting a WIFI hotpot to connect. As shown in FIG. 11, the steps are included:

In step 1101, the communication terminal searches for and just saves a non-operator WIFI hotpot without encryption, then obtains a list of WIFI hotpots without encryption;

In step 1102, the communication terminal connects to the first WIFI hotpot without encryption designated by user; certainly, the communication terminal may also select a WIFI hotpot without encryption according to other rules designated by user;

In step 1103, the communication terminal encrypts verification information which is to be sent, and encrypts the verification information into binary verification data information; specially, 128-bit AES algorithm may be used in this step, and other encryption algorithms can be used certainly.

In step 1104, the communication terminal sends the encrypted verification information to a corresponding network server.

In step 1105, the communication terminal determines whether the verification information is sent successfully, if so, it is to jump to step 1106; if not, it is to jump to step 1113.

In step 1106, the network server verifies the received verification information and feeds back encrypted verification information to the communication terminal when verifying that the received verification information is consistent with the locally-preset verification information.

In step 1107, the communication terminal receives verification information sent by the network server.

In step 1108, the communication terminal determines whether the verification information is received successfully, if so, it is to jump to step 1109; if not, it is to jump to step 1113.

In step 1109, the communication terminal decrypts the received verification information.

In step 1110, the communication terminal compares decrypted verification information with locally-preset verification information.

In step 1111, the communication terminal determines whether the decrypted verification information is consistent with locally-preset verification information; if so, it is to jump to step 1112; if not, it is to jump to step 1113;

In step 1112, the connection with the WIFI hotpot without encryption is kept.

In step 1113, the currently connected WIFI hotpot is deleted;

In step 1114, it is to determine whether there is any WIFI hotpot remained in the list of WIFI hotpot without encryption, if so, it is to jump to step 1102; if not, it is to end the process.

The process of verifying the received verification information by the network server in step 1106 is similar to the process as shown in FIG. 9, only 128-bit AES encryption algorithm may be used when the network server encrypts verification information.

Therefore according to the solution provided in embodiments of the present document, by means of preset verification information, the communication terminal realizes to screen automatically a WIFI hotpot which needs a second verification from WIFI hotpots without encryption and does not need to verify and select by hand, which simplifies operation process of WIFI communication and improves the satisfaction of user experience in a large degree. At the same time, in a large degree, the communication terminal also avoids to connect wrongly to a WIFI hotpot without encryption which is provided by an operator and needs a second verification, which reduces users' economic expense and further improves users' satisfaction.

The person skilled in art should understand that embodiments of the present document can provide a method, a system or computer program products. Therefore the embodiments of present document can be hardware embodiments, software embodiments, or hardware-software combination embodiments. At the same time, the present document can be implemented in a form of computer program product with one or more computer storage medium that contain computer available program codes.

The present document is described with reference to flow or block diagram of a method, equipment (system) and computer program product according to the embodiments of the present document It should be understood that every flow and/or block of a flow diagram and/or block diagram and combination of flow and/or block of a flow diagram and/or block diagram can be implemented by computer program instructions. The computer program instructions can be provided to a processor of a general-purpose computer, a special-purpose computer, an embedded processor or other programmable data processing devices to produce a machine. Thereby, the instructions executed by the processor of the computer or other programmable data processing devices generate an apparatus for implementing functions specified in one or more flows in the flowcharts and/or one or more blocks in the block diagrams.

The computer program instructions also can be stored in a computer readable memory which can make computer or other programmable data processing devices work in a specific way. Thereby, the instructions stored in computer readable memory generate an article of manufacture comprising instruction means for implementing functions specified in one flow or more flows of the flow charts and/or one block or more blocks of the block diagrams.

The computer program instructions also can be loaded onto a computer or other programmable data processing devices, in order to enable a series of operation steps to be performed on the computer or other programmable devices to generate a computer-implemented process. Thereby, the instructions executed on the computer or other programmable devices provide steps of implementing functions specified in one flow or more flows of the flow charts and/or one block or more blocks of the block diagrams.

The above is just a further detailed description of the present document in combination with specific embodiments, rather than considering that specific embodiments of the present document are limited to the above. For the ordinary person skilled in the art which belongs to the technical field of the present document, some simple deductions and substitutions can also be made without departing from the rule of the present document, and these deductions and substitutions should be included in the protection scope of the present document.

1. A method for connecting a WIFI hotpot, comprising:
connecting, by a communication terminal, to a WIFI hotpot without encryption;
sending, by the communication terminal, preset verification information to a network server; and
receiving, by the communication terminal, verification information fed back by the network server and comparing with the locally-preset verification information, then keeping the connection with the WIFI hotpot when the verification information fed back by the network server is consistent with the locally-preset verification information.

2. The method for connecting a WIFI hotpot according to claim 1, wherein, when the communication terminal determines that the verification information fed back by the network server is not consistent with the locally-preset verification information, the method further comprises:
reselecting and connecting to a WIFI hotpot without encryption by the communication terminal; or
after deleting, by the communication terminal, the WIFI hotpot from a list of WIFI hotpots without encryption, then reselecting and connecting to a WIFI hotpot without encryption by the communication terminal; or
exiting, by the communication terminal, the connection with the WIFI directly.

3. The method for connecting a WIFI hotpot according to claim 1, wherein, before connecting, by the communication terminal, to a WIFI hotpot without encryption, the method further comprises:
deleting an operator WIFI hotpot from WIFI hotpots without encryption searched out by the communication terminal according to preset operator WIFI hotpot information.

4. The method for connecting a WIFI hotpot according to claim 1, wherein, before sending, by the communication terminal, preset verification information to a network server, the method further comprises:
encrypting, by the communication terminal, the verification information which is to be sent; and/or
before comparing, by the communication terminal, the received verification information with the locally-preset verification information, the method further comprises:
decrypting the received verification information.

5. A method for selecting a WIFI hotpot, comprising:
connecting, by a communication terminal, to a WIFI hotpot without encryption;
sending, by the communication terminal, preset verification information to a network server, and presetting verification information in the network server;
receiving, by the network server, verification information sent by the communication terminal and comparing with locally-preset verification information, then feeding back verification information to the communication terminal when the verification information sent by the communication terminal is consistent with the locally-preset verification information;
receiving, by the communication terminal, verification information fed back by the network server and comparing with locally-preset verification information, then keeping the connection with the WIFI hotpot when the verification information fed back by the network server is consistent with the locally-preset verification information.

6. The method for selecting a WIFI hotpot according to claim 5, wherein, when the network server determines that verification information sent by the communication terminal is not consistent with the locally-preset verification information, or the communication terminal determines that the verification information fed back the network server is not consistent with the locally-preset verification information, the method further comprises:
reselecting and connecting to a WIFI hotpot without encryption by the communication terminal; or
after deleting, by the communication terminal, the WIFI hotpot from a list of WIFI hotpots without encryption, then reselecting and connecting to a WIFI hotpot without encryption by the communication terminal; or
exiting, by the communication terminal, the connection with the WIFI directly.

7. The method for selecting a WIFI hotpot according to claim 5, wherein, before sending, by the communication terminal, preset verification information to a network server, the method further comprises:
encrypting, by the communication terminal, the verification information which is to be sent;
accordingly, before comparing, by the network server, the received verification information with the locally-preset verification information, the method further comprises:
decrypting the received verification information.

8. The method for selecting a WIFI hotpot according to claim 5, wherein, before feeding back, by the network server, the verification information, the method further comprises:
encrypting, by the network server, the verification information which is to be sent;
accordingly, before comparing, by the communication terminal, the received verification information with the locally-preset verification information, the method further comprises:
decrypting the received verification information.

9. The method for selecting a WIFI hotpot according to claim 7, wherein the communication terminal encrypts the verification information which is to be sent into binary verification data information.

10. The method for selecting a WIFI hotpot according to claim 8, wherein the network server encrypts the verification information which is to be sent into binary verification data information.

11. A communication terminal, comprising: a WIFI communication module, a first sending module, a first receiving module and a first processing module; wherein,
the WIFI communication module is configured to connect to a WIFI hotpot without encryption;
the first sending module is configured to send verification information locally preset in the communication terminal to a network server;
the first receiving module is configured to receive verification information fed back by the network server;
the first processing module is configured to compare the verification information received by the first receiving module with the verification information locally preset in the communication terminal, and keep the connection between the WIFI communication module and the WIFI hotpot when the verification information received by the first receiving module is consistent with the verification information locally preset in the communication terminal.

12. The communication terminal according to claim 11, wherein the communication terminal further comprises a reselecting module, and the reselecting module is configured to, when the first processing module determines that the verification information received by the first receiving module is not consistent with the verification information locally preset in the communication terminal, reselect a WIFI hotpot without encryption to connect to the WIFI communication module; or delete the WIFI hotpot from a list of WIFI hotpots without encryption, then reselect a WIFI hotpot without encryption to connect to the WIFI communication module.

13. The communication terminal according to claim 11, wherein the communication terminal further comprises a screening module, and the screening module is configured to delete an operator WIFI hotpot from WIFI hotpots without encryption searched out by the WIFI communication terminal according to preset operator WIFI hotpot information before the WIFI communication module selects and connects to a WIFI hotpot without encryption.

14. The communication terminal according to claim 11, wherein the communication terminal further comprises a first encrypting module and a first decrypting module, and the first encrypting module is configured to encrypt the verification information which is to be sent before the first sending module sends the verification information to the network server; and/or,
the first decrypting module is configured to decrypt the verification information received by the first receiving module before the first processing module compares the verification information received by the first receiving module with the verification information locally preset in the communication terminal.

15. A communication system, comprising: a communication terminal and a network server; wherein,
the communication terminal comprises: a WIFI communication module, a first sending module, a first receiving module and a first processing module; and the network server comprises a second receiving module, a second sending module and a second processing module;
the WIFI communication module is configured to select and connect to a WIFI hotpot without encryption;
the first sending module is configured to send verification information locally preset in the communication terminal to the second receiving module;
the second receiving module is configured to receive the verification information sent by the first sending module;
the second processing module is configured to compare the verification information received by the second receiving module with verification information locally preset in the network server, and make verification information be sent by the second sending module to the first receiving module when the verification information received by the second receiving module is consistent with the verification information locally preset in the network server;
the first receiving module is configured to receive the verification information sent by the second sending module;
the first processing module is configured to compare the verification information received by the first receiving module with the verification information locally preset in the communication terminal, and keep the connection between the WIFI communication module and the WIFI hotpot when the verification information received by the first receiving module is consistent with the verification information locally preset in the communication terminal.

16. The communication system according to claim 15, wherein the communication terminal further comprises: a first encrypting module and a first decrypting module, and the network server further comprises a second decrypting module and a second encrypting module, wherein,
the first encrypting module is configured to encrypt the verification information which is to be sent before the first sending module sends the verification information to the network server;
the first decrypting module is configured to decrypt verification information received by the first receiving module before the first processing module compares verification information received by the first receiving module with the verification information locally preset in the communication terminal;
the second decrypting module is configured to decrypt verification information received by the second receiving module before the second processing module compares verification information received by the second receiving module with the verification information locally preset in the network server;
the second encrypting module is configured to encrypt verification information which is to be sent before the second sending module sends the verification information to the communication terminal.

17. A computer storage device, comprising:
a group of instructions, which, when executed, cause at least one processor to implement a method for connecting a WIFI hotpot according to claim 1 or a method for selecting a WIFI hotpot, wherein the method for selecting a WIFI hotpot comprises:
connecting, by a communication terminal, to a WIFI hotpot without encryption;
sending, by the communication terminal, preset verification information to a network server, and presetting verification information in the network server;
receiving, by the network server, verification information sent by the communication terminal and comparing with locally-preset verification information, then feeding back verification information to the communication terminal when the verification information sent by the communication terminal is consistent with the locally-preset verification information;
receiving, by the communication terminal, verification information fed back by the network server and comparing with locally-preset verification information, then keeping the connection with the WIFI hotpot when the verification information fed back by the network server is consistent with the locally-preset verification information.
